(19) United States
(12) Patent Application Publication
(10) Pub. No.: US 2019/0313020 A1
(43) Pub. Date: Oct. 10, 2019

(54) Mobile Tracking Camera Device

(71) Applicant: Jeffery Brent Snyder, Erie, CO (US)

(72) Inventor: Jeffery Brent Snyder, Erie, CO (US)

(21) Appl. No.: 15/947,081

(22) Filed: Apr. 6, 2018

(51) Int. Cl. H04N 5/232; H04N 5/225

(52) U.S. Cl. CPC H04N 5/23238; H04N 5/2252; H04N 5/23296; H04N 5/23219

(57) ABSTRACT

An example apparatus includes a housing including in a bottom thereof a recess. The apparatus also includes a base plate rotatably coupled to the housing and disposed within the recess. The apparatus additionally includes a motor configured to rotate the housing with respect to the base plate. The apparatus further includes a first image capture device disposed within the housing and having a first field of view and a second image capture device disposed within the housing and having a second field of view different than the first field of view. The apparatus yet further includes a processor operable to provide instructions to cause the motor to rotate the housing with respect to the base plate to maintain one or more objects in an environment within at least one of the first field of view or the second field of view.

### BACKGROUND

A camera is an optical instrument designed for capturing images, which may be individual still photographs, sequences of images that make up a video, or a combination thereof. The camera may capture images of a scene by using lenses to focus light from the scene onto an electronic sensor, photographic film, or another light-sensitive medium. Cameras may be used to film a person participating in an activity such as a sporting event. For example, a parent may wish to record his or her child participating in a team sport. Similarly, athletes may wish to record themselves in games or practices (e.g., doing drills or exercises to improve their form or speed). Additionally, cameras may be used to record other activities aside from sports.

### SUMMARY

In an example embodiment, a camera device may include multiple image capture devices. A first of the image capture devices may have a field of view larger than a second of the image capture devices, thereby allowing it to simultaneously capture image data representing a larger portion of the environment. The second of the image capture devices may, due to its smaller field of view, capture image data of the environment with a higher resolution. Accordingly, data from the first of the image capture devices may be used to monitor the environment for objects of interest and track and identified objects of interest, while the second of the image capture devices may be used to film any identified objects of interest. The image capture devices may be disposed within a housing configured to rotate with respect to a base plate which provides a mechanical coupling for connecting the camera device to a support structure such as a tripod or other stabilizing device. The image capture devices may be fixed with respect to one another, or they may be independently rotatable relative to the base plate. The camera device may be remotely controllable to track different targets within the environment, pan and tilt with respect to the environment, and transmit video streams of different targets to viewing, distribution, or recording devices.

In a first embodiment, a system is provided that includes a base plate and a housing rotatable with respect to the base plate. The system also includes a motor configured to rotate the housing with respect to the base plate. The system additionally includes a first image capture device disposed within the housing and having a first field of view and a second image capture device disposed within the housing and having a second field of view. The system further includes a control system configured to receive, from the first image capture device, first data representing a portion of an environment within the first field of view. The control system is also configured to determine, based on the first data, a first object within the portion of the environment. The control system is additionally configured to, based on a position of the first object, determine a first direction in which to rotate the housing. The control system is further configured to provide instructions to cause the motor to rotate the housing in the first direction. The control system is yet further configured to receive, from the second image capture device, second data representing the first object.

In a second embodiment, an apparatus is provided that includes a housing including in a bottom thereof a recess and a base plate rotatably coupled to the housing and disposed within the recess. The apparatus also includes a motor configured to rotate the housing with respect to the base plate. The apparatus additionally includes a first image capture device disposed within the housing and having a first field of view and a second image capture device disposed within the housing and having a second field of view. The apparatus further includes a processor operable to provide instructions to cause the motor to rotate the housing with respect to the base plate to maintain one or more objects in an environment within at least one of the first field of view or the second field of view.

In a third embodiment, a method is provided that includes receiving, by a control system, from a first image capture device disposed within a housing and having a first field of view, first data representing a portion of an environment within the first field of view. The method also includes determining, by the control system and based on the first data, a first object within the portion of the environment, where a position of the first object is beyond a second field of view of a second image capture device disposed within the housing. The second field of view is smaller than the first field of view. The method additionally includes, based on the position of the first object, determining, by the control system, a first direction in which to rotate the housing with respect to a base plate to position the first object within the second field of view. The method further includes providing, by the control system, instructions to cause a motor to rotate the housing in the first direction. The method yet further includes receiving, by the control system and from the second image capture device, second data representing the first object.

In a fourth embodiment, a non-transitory computer readable storage medium is provided having stored thereon instructions that, when executed by a computing device, cause the computing device to perform operations. The operations include receiving, from a first image capture device disposed within a housing and having a first field of view, first data representing a portion of an environment within the first field of view. The operations also include determining, based on the first data, a first object within the portion of the environment, where a position of the first object is beyond a second field of view of a second image capture device disposed within the housing. The second field of view is smaller than the first field of view. The operations additionally include, based on the position of the first object, determining a first direction in which to rotate the housing with respect to a base plate to position the first object within the second field of view. The operations further include providing instructions to cause a motor to rotate the housing in the first direction. The operations yet further include receiving, from the second image capture device, second data representing the first object.

In a fifth embodiment, a system is provided that includes means for receiving, from a first image capture device disposed within a housing and having a first field of view, first data representing a portion of an environment within the first field of view. The system also includes means for determining, based on the first data, a first object within the portion of the environment, where a position of the first object is beyond a second field of view of a second image capture device disposed within the housing. The second field of view is smaller than the first field of view. The system additionally includes means for, based on the position of the first object, determining a first direction in which to rotate the housing with respect to a base plate to position the first object within the second field of view. The system further includes means for providing instructions to cause a motor to rotate the housing in the first direction. The system yet further includes means for receiving, from the second image capture device, second data representing the first object.

These as well as other embodiments, aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a camera device, in accordance with example embodiments.

FIG. 3A illustrates a housing of a camera device, in accordance with example embodiments.

FIGS. 3B and 3C illustrate a housing of a camera device, in accordance with example embodiments.

FIG. 3D illustrates a housing and yoke of a camera device, in accordance with example embodiments.

FIG. 4A illustrates a side cross-section of a camera device, in accordance with example embodiments.

FIG. 4B illustrates a side cross-section of a camera device, in accordance with example embodiments.

FIG. 5 illustrates a camera device tracking multiple targets, in accordance with example embodiments.

FIG. 6 illustrates a user interface for a camera device, in accordance with example embodiments.

FIG. 7 illustrates a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless indicated as such. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For purpose of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment. In the figures, similar symbols typically identify similar components, unless context dictates otherwise. Further, unless otherwise noted, figures are not drawn to scale and are used for illustrative purposes only. Moreover, the figures are representational only and not all components are shown. For example, additional structural or restraining components might not be shown.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

I. Overview

Cameras may be used to film individuals participating in a variety of events ranging from sports to video teleconferences. In many cases, individuals may desire the filming process to be automated such that the camera does not have to be manually repositioned or adjusted as the individual moves around an environment. For example, athletes may wish to record themselves playing or practicing a sport to commemorate or evaluate their performance. Notably, an athlete may desire that the camera track and focus on recording him or her, rather than recording a static portion of the environment. Similarly, a parent may wish to record his or her child participating in a sport without having to manually record the entire sporting event or hiring a professional to do the same. On the other hand, a coach of a team, for example, may wish to film the “action” of the game (e.g., the area on the field nearby where the ball is), rather than focusing on any individual player.

Regardless of the content to be filmed, users may generally desire that the camera be programmable to track and film one or more targets, objects, or scenes whose position in the environment may change over time. Similarly, it may be desirable for the camera to have a small and compact form factor so that it can be easily stored, transported, and set up to film different environments.

Accordingly, described herein is a camera system that includes multiple image capture devices within a single compact housing. Data from the multiple image capture devices may be used to track and film targets (e.g., athletes) as they move through an environment. To that end, the housing of the camera may be rotatable, by way of a motor, with respect to a base (e.g., a cylindrical base plate). The base may provide a mechanical interface for connecting the camera to a support structure such as a tripod, a yoke, or a harness, among other possibilities. The housing may, for example, have a rectangular shape, a cylindrical shape, a disc shape, or a combination thereof, and may include in a bottom of a portion thereof a recess in which a base plate is situated. The base plate may form part of the housing.

In some implementations, image capture devices that make up the camera may be situated directly inside the housing. Alternatively, in other implementations, the image capture devices may be connected to the housing by way of telescopic arms, thereby allowing the position of the image capture devices to be adjusted relative to the housing (e.g., to fold the camera system into a compact form factor for storage). Such adjustment may be performed manually (e.g., by a user) or automatically (e.g., by motors).

In one example, the camera system may include two image capture devices situated within the housing in fixed positions with respect to one another. A first of the image capture devices may have a first field of view larger than a second field of view of the second image capture device. Thus, the first image capture device may be referred to as a wide-angle image capture device. The relative size of the first and second fields of view may be determined by the respective focal lengths of the lenses situated along the optical paths of each of the first and second image capture devices. The first and second fields of view may overlap one another. For example, the second, smaller field of view may be centered within the first, larger field of view, thereby allowing both fields of view to simultaneously follow the target as the housing is rotated.

The wide-angle image capture device may generate image data that represents a larger portion of the environment than image data from the second image capture device, which may be referred to as the main image capture device. Image data from the wide-angle image capture device may, however, include distortion due to the wider angle of view provided by the lenses thereof. On the other hand, image data from the main image capture device may be free of any such distortion, and may represent portions of the environment with a higher resolution than image data from the wide-angle image capture device.

Accordingly, image data from the wide-angle image capture device may be used primarily to scan the environment for features of interest, thereby facilitating tracking of different targets. Image data from the main image capture device may be used primarily to film the target within the environment, thereby capturing distortion-free, high-resolution images of the target. Nevertheless, in some cases, image data from both the first and second sensor may be saved or transmitted for viewing. Tracking of the target may be facilitated by one or more feature recognition and tracking algorithms, including computer vision, machine learning, and artificial intelligence implementations.

In some implementations, the first field of view of the first image capture device and the second field of view of the second image capture device may each be adjustable. The sizes of the first and second fields of view may be adjusted by adjusting the respective focal lengths of the lenses situated along the optical paths of each of the first and second image capture devices (e.g., by zooming in or out). Image data from each of the first and second image capture devices may be used for tracking and filming the target within the environment depending on the relative size of the two fields of view.

For example, the second image capture device may initially be zoomed in on a target to track and film the target. The first image capture device may be zoomed out to monitor a larger portion of the environment around the target. The camera system may detect a new (i.e., different) target or event of interest outside of the second field of view but inside the first field of view representing the larger portion of the environment monitored by the first image capture device. In response, the camera system may start to track and film the new target or event of interest using the first image capture device (rather than the second image capture device), which may be adjusted to zoom in and focus on the new target or event of interest. The second image capture device may be adjusted to zoom out and monitor the larger portion of the environment that the first image capture device previously monitored. Accordingly, any targets or events of interest may start to be filmed immediately after they are perceived, thus increasing the amount of footage of interest captured by the camera system. Notably, by switching to using the first image capture device to film the new target or event of interest rather than repositioning or adjusting the zoom of the second image capture device, the camera system captures any footage that would otherwise not be captured while the second image capture device was being adjusted.

In another example, the camera system may include two image capture devices situated within the housing in adjustable positions with respect to one another so that the field of view of each image capture device can be independently repositioned. The housing may include two stacked, coaxial portions, each housing one of the image capture devices. Each portion may be rotatable with respect to the other and with respect to the base. Thus, the first field of view may be panned right while the second field of view is panned left, for example. The size of the two fields of view may be different, thereby allowing image data representing the wider field of view to be used to monitor a larger portion of the environment for object of interest, as discussed above. Additionally, in some cases, the sizes of the two fields of view may be adjustable, allowing for detection, tracking, and filming of targets to be performed using data from the image capture device that has the best view of a target.

However, in some examples, the fields of view may be of equal size. For example, rather than including a wide-angle image capture device, the camera system may include more than two image capture devices. Image data from a first one of the image capture devices may be recorded, while image data from the other two or more image capture devices may be used to monitor the environment for features of interest. The first one of the image capture devices may be repositioned to record a target based on the image data from the other two or more image capture devices. The other two image capture devices may be situated at different positions within the housing and may be angled such that their fields of view begin to overlap at some minimum distance away from the camera device. In some examples, regardless of the sizes of the fields of view, each image capture device may be independently rotatable to track different and independent targets. Also, in some implementations, image data from all three image capture devices may be recorded.

Additionally, the camera system may include one or more additional motors configured to adjust a vertical position (i.e., tilt) of the fields of view of the image capture devices by rotating the image capture devices with respect to the housing. The tilt motors and the motors that rotate the housing with respect to the base plate may do so by way of a friction drive, a belt drive, a gear box, or a direct drive, among other possibilities. One or more encoders may be used to monitor the rotational (i.e., angular) positions of the image capture devices and, based thereon, the motors may be configured to control the tilt and pan angles of the image capture devices.

In some examples, the camera system may also include a wireless tag. The wireless tag may be placed on a target to be followed and may transmit, to the camera device, data representing a location of the wireless tag, a speed of the wireless tag, an angular position of the wireless tag relative to the camera device, and parameters indicative of a health of the target (e.g., heart rate, breathing rate, etc.). Thus, the tag may facilitate tracking of the target as it moves through the environment. In some implementations, the tag may include therein various sensors such as, for example, inertial measurement units or heart rate sensors, among other possibilities. The sensors may be integrated with the tag, or may be provided as separate units that are communicatively connected to the tag.

The camera system may additionally be configured to communicate with a remote viewing device such as a smartphone or a tablet computer, for example. The remote viewing device may be used to select a target for the camera system to track and film, and to manually adjust a pan or tilt angles of the image capture devices. The remote viewing device may also be used to program the camera system to perform one or more specific camera movements or sequences thereof. The camera system may be configured to track the selected target and transmit, to the remote viewing device, a video stream representing the tracked target. The video stream may include image data from the main image capture device, allowing the viewing device to monitor and adjust the video content being recorded by the camera system. However, the video stream may also include image data from the wide-angle image capture device, allowing the remote viewing device to monitor a larger extent of the environment. The viewing device may be used to switch between viewing the image data from the main image capture device and the image data from the wide-angle image capture device, as well as to switch targets tracked by the camera system, image capture modes in which the camera system operates, and the frame size with which the camera system films a target, among various other uses.

II. Example Computing Device

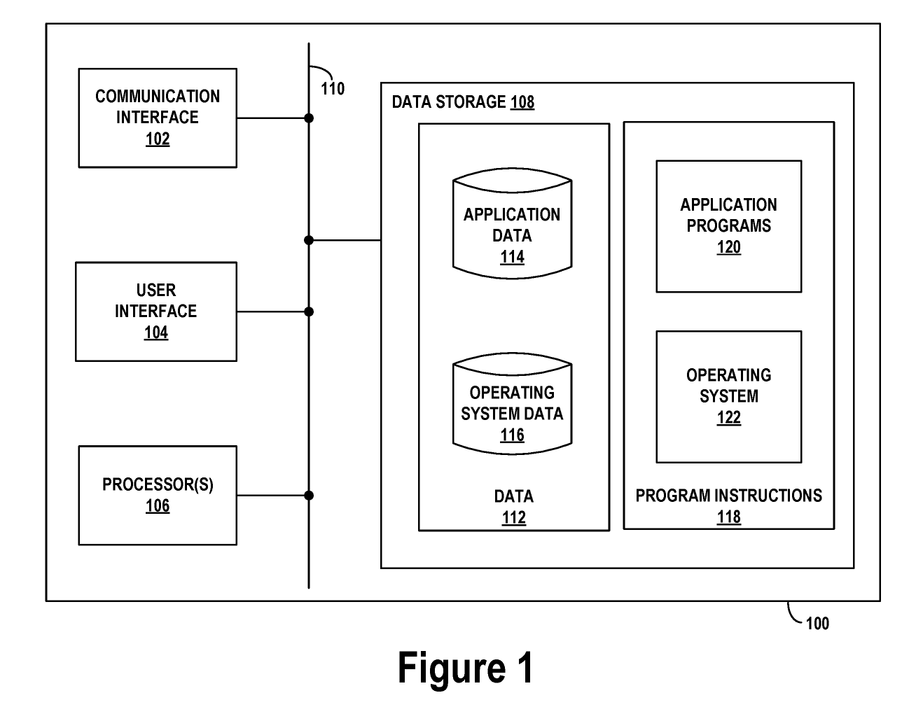

FIG. 1 illustrates a simplified block diagram showing some of the components of an example computing device 100. By way of example and without limitation, computing device 100 may be a cellular mobile telephone (e.g., a smartphone), a computer (such as a desktop, notebook, tablet, handheld computer, server computer, or a specialized, purpose-built computer), a personal digital assistant (PDA), a home or business automation component, a digital television, a smartwatch, or some other type of device capable of operating in accordance with the example embodiments described herein. It should be understood that computing device 100 may represent combinations of hardware and software that are configured to carry out the disclosed operations. Computing device 100 may represent the remote control and remote viewing devices described herein. Additionally, computing device 100 or the components thereof may be included in various embodiments of the camera devices described herein.

As shown in FIG. 1, computing device 100 may include communication interface 102, user interface 104, processor 106 and data storage 108, all of which may be communicatively linked together by a system bus, network, or other connection mechanism 110.

Communication interface 102 may allow computing device 1.00 to communicate, using analog or digital modulation, with other devices, access networks, and/or transport networks. Thus, communication interface 102 may facilitate circuit-switched and/or packet-switched communication, such as plain old telephone service (POTS) communication and/or Internet protocol (IP) or other packetized communication. For instance, communication interface 102 may include a chipset and antenna arranged for wireless communication with a radio access network or an access point. Also, communication interface 102 may take the form of or include a wireline interface, such as an Ethernet, Universal Serial Bus (USB), or High-Definition Multimedia Interface (HDMI) port. Communication interface 102 may also take the form of or include a wireless interface, such as a Wi-Fi, BLUETOOTH®, infrared (IR) light, global positioning system (GPS), or wide-area wireless interface (e.g., WiMAX or 3GPP Long-Term Evolution (LTE)). However, other forms of physical layer interfaces and other types of standard or proprietary communication protocols may be used over communication interface 102. Furthermore, communication interface 102 may comprise multiple physical communication interfaces (e.g., a interface, a BLUETOOTH® interface, and a wide-area wireless interface).

User interface 104 may operate to allow computing device 100 to interact with a user, such as to receive input from the user and to provide output to the user. Thus, user interface 104 may include input components such as a keypad, keyboard, touch-sensitive panel, computer mouse, trackball, joystick, microphone, and so on. User interface 104 may also include one or more output components such as a display screen that, for example, may be combined with a presence-sensitive panel. The display screen may be based on cathode ray tube (CRT), liquid-crystal display (LCD), light-emitting diode (LED) technologies, organic light emitting diode (OLED) technologies, or other technologies now known or later developed. User interface 104 may also be configured to generate audible output(s), via a speaker, speaker jack, audio output port, audio output device, earphones, and/or other similar devices.

In some embodiments, user interface 104 may include one or more buttons, switches, knobs, and/or dials that facilitate interaction with computing device 100. It may be possible that some or all of these buttons, switches, knobs, and/or dials are implemented by way of graphics on a presence-sensitive panel.

Processor 106 may comprise one or more general purpose processors e.g., microprocessors—and/or one or more special purpose processors—e.g., digital signal processors (DSPs), graphics processing units (GPUs), floating point units (FPUs), network processors, or application-specific integrated circuits (ASICs).

Data storage 108 may include one or more volatile and/or non-volatile storage components, such as magnetic, optical, flash, or organic storage, and may be integrated in whole or in part with processor 106. Data storage 108 may include removable and/or non-removable components.

Processor 106 may be capable of executing program instructions 118 (e.g., compiled or non-compiled program logic and/or machine code) stored in data storage 108 to carry out the various operations described herein. Therefore, data storage 108 may include a non transitory computer-readable medium, having stored thereon program instructions that, upon execution by computing device 100, cause the computing device 100 to carry out any of the methods, processes, or operations disclosed in this specification and/or the accompanying drawings. The execution of program instructions 118 by processor 106 may result in processor 106 using data 112.

By way of example, program instructions 118 may include an operating system 122 (e.g., an operating system kernel, device driver(s), and/or other modules) and one or more application programs 120 (e.g., camera functions, image processing functions, address book, email, web browsing, social networking, and/or gaming applications) installed on computing device 100. Similarly, data 112 may include operating system data 116 and application data 114. Operating system data 116 may be accessible primarily to operating system 122, and application data 114 may be accessible primarily to one or more of application programs 120. Application data 114 may be arranged in a file system that is visible to or hidden from a user of computing device 100.

Application programs 120 may communicate with operating system 122 through one or more application programming interfaces (APIs). These APIs may facilitate, for instance, application programs 120 reading and/or writing application data 114 transmitting or receiving information via communication interface 102, receiving and/or displaying information on user interface 104, and so on.

In some examples, application programs 120 may be referred to as “apps” for short. Additionally, application programs 120 may be downloadable to computing device 100 through one or more online application stores or application markets. However, application programs can also be installed on computing device 100 in other ways, such as via a web browser or through a physical interface (e.g., a USB port) on computing device 100.

It should be understood that the components of the computing device may be distributed, logically or physically, over multiple devices of the same or of a different type. Additionally, multiple computing devices may work in combination to perform the operations described herein.

III. Example Camera System Design

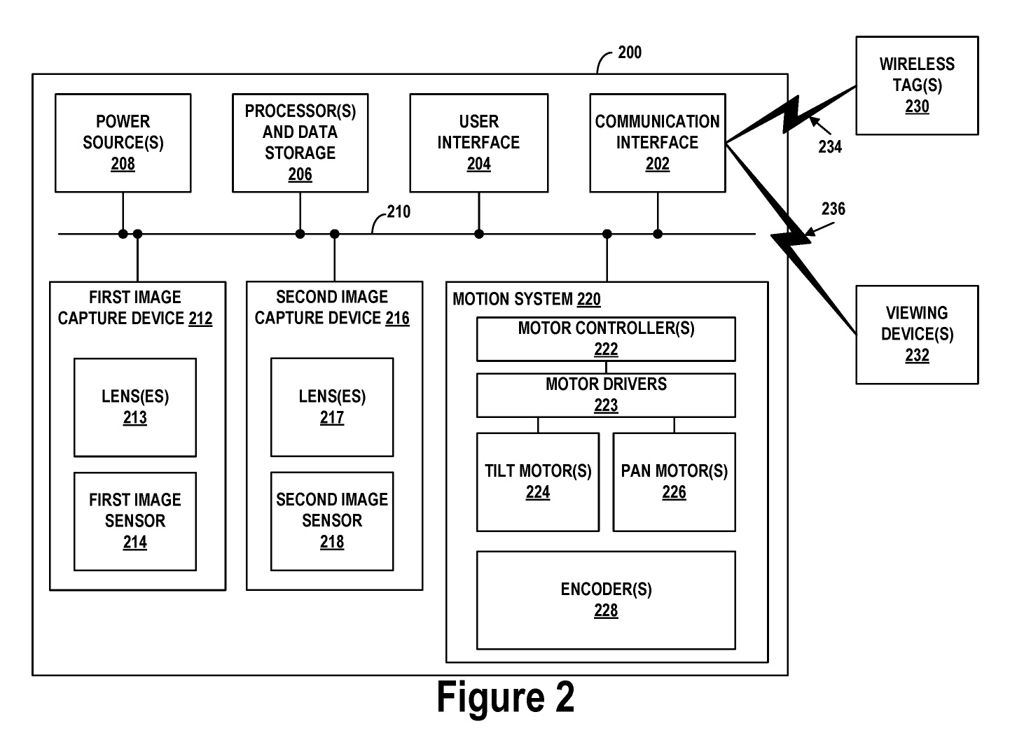

FIG. 2 illustrates a simplified block diagram showing some of the components of an example camera device 200. Camera device 200 may include communication interface 202 user interface 204, and processor(s) and data storage 206, which may be similar to communication interface 102, user interface 104, processor(s) 106, and data storage 108, respectively, discussed with respect to FIG. 1. Processor(s) and data storage 206 may additionally be configured to store and execute instructions implementing a plurality of image-processing operations. In one example, the operations may include generation of high dynamic range (HDR) images based on a plurality of images captured at different exposure levels. The operations may also include stabilization of video captured by camera device 200, among other possibilities.

Camera device 200 may also include power source(s) 208 configured to supply power to various components of camera device 200. Among other possible power sources, power source(s) 208 may include batteries (e.g., rechargeable lithium ion batteries), supercapacitors, solar panels, and/or other types of power systems (e.g., a wall socket connection). Power source(s) 208 may charge using various types of charging, such as wired connections to an outside power source or wireless charging.

Camera device 200 may additionally include first image capture device 212 and second image capture device 216. First image capture device 212 and second image capture device 216 may be configured to film (i.e., capture photo or video of) an environment or scene. To that end, first image capture device 212 may include lens(es) 213 and first image sensor 214. Similarly, second image capture device 216 may include lens(es) 217 and wide angle image sensor 218. In some implementations, first image capture device 212 may have a smaller field of view than second image capture device 216. Lens(es) 213 may thus have a longer focal length (e.g., effective focal length when multiple lenses are combined) than lens(es) 217. Second image capture device 216 may, in some cases, be referred to as a wide-angle image capture device. Image capture devices 212 and 216 may be configured to capture images and video at various resolutions (e.g., 4K), various frame rates (e.g., 30 frames per second, 60 frames per second, etc.), and with various additional effects (e.g., thermal imaging, night vision, low-light imaging, 3D imaging, etc.).

Lens(es) 213 may include macro lenses, telephoto lenses, or zoom lenses, among other possibilities, while lens(es) 217 may additionally include wide-angle lenses or ultra-wide angle (i.e., fisheye) lenses. Accordingly, second image sensor 218 may be configured to capture images of a wider field of view than first image sensor 214 (although second image sensor 218 might not itself be wider than first image sensor 214). First image sensor 214 and second image sensor 218 may be, for example, charge coupled device (CCD) sensors or complementary metal-oxide-semiconductor (CMOS) sensors. Lens(es) 213 and 217, as well as image sensors 214 and 218, may be removably connected to camera device 200 to allow for the lenses and image sensors to be changed or upgraded.

The respective positions of lens(es) 213 and 217 in relation to sensors 214 and 218, respectively, may be adjustable by way of one or more actuators (e.g., motors, not shown) to control a level of focus of images captured by sensors 214 and 218. For example, the respective positions of lens(es) 213 and 217 may be adjusted based on instructions generated by processor(s) 206 to automatically focus image capture devices 212 and 216 on an object of interest within the environment. The extent of adjustment in the positions of lens(es) 213 and 217 may be based on sensor data indicative of a distance between camera device 200 and the object of interest (i.e., active autofocus), based on phase detection or contrast detection algorithms applied to captured images (i.e., passive autofocus), or a combination thereof, among other possibilities. Similarly, when lens(es) 213 or 217 include one or more zoom lenses (i.e., variable magnification lenses), the one or more zoom lenses may be adjustable to control a level of magnification of the images captured by sensors 214 and 218.

In some embodiments, image data from first image capture device 212 and second image capture device 216 may be processed or analyzed (e.g., to identify and track features of interest) by separate processors to improve throughput of camera device 200. First and second image capture device 212 and 216 may be configured to simultaneously capture and generate video and photo data. In one example, one of image capture devices 212 and 216 may capture and generate video data while the other captures and generates photo data. Alternatively, both image capture devices 212 and 216 may simultaneously capture and generate both photo and video data. Such simultaneous capture of video and photo data by image capture device 212 and 216 may be a configurable setting of camera device 200, modifiable by way of user interface 204, for example.

Additionally, in some embodiments, first image capture device 212 and second image capture device 216 may be positioned at a known distance relative to one another, thus allowing camera device 200 to determine distances (i.e., depths) between itself and features within the environment by way of passive stereo vision. Determining distances between camera device 200 and features within the environment may facilitate the tracking of features of interest within the captured image data, as well as enable automatic adjustments of values to which various parameters of camera device 200 are set.

Camera device 200 may also include one or more microphones (not shown) configured to capture audio, or one or more audio input interfaces allowing for camera device 200 to receive audio from external microphones connected thereto. The received audio may be synchronized with video captured by first image capture device 212 or second image capture device 216. Additionally, the microphone may be used to receive voice commands for controlling operating of camera device 200. The different components of camera device 200 may be communicatively linked together by a system bus, network, or other connection mechanism 210.

Camera device 200 may also include motion system 220, which may be configured to reposition first image capture device 212 and second image capture device 216, or components thereof, to direct the fields of view thereof onto different portions of the environment. The fields of view of first image capture device 212 and second image capture device 216 may be repositionable independently, or may be fixed with respect to one another. Motion system 220 may include motor controller(s) 222, motor drivers 223, tilt motor(s) 224, pan motor(s) 226, and encoders 228. Motor controller(s) 222 may be configured to control tilt motor(s) 224 and pan motor(s) 226 according to a desired position, velocity, or acceleration based on feedback from encoder(s) 228. Motor controller(s) 222 may thus implement a feedback system, such as a tunable position-integral-derivative (PID) feedback system. Motor controller(s) 222 may control motors 224 and 226 based on instructions from processor(s) 206, user interface 204, or communication interface 202.

Motor drivers 223 may be configured to supply the current needed to drive motors 224 and 226 according to control signals generated by motor controller(s) 222. The implementation of motor drivers 223 may depend on the type of motors 224 and 226, which may be direct current (DC) motors such as brushed motors, brushless motors, or servomotors, or alternating current (AC) motors. DC motors, for example, may be driven by one or more transistors arranged to form an H-bridge circuit.

Tilt motor(s) 224 may be configured to control tilt angles of first image capture device 212, second image capture device 216, or portions thereof. Similarly, pan motor(s) 226 may be configured to control a pan angle of first image capture device 212, second image capture device 216, or components thereof. Thus, motors 224 and 226 may be used to move first image capture device 212 and second image capture device 216 relative to the environment, thereby controlling the portion of the environment that is filmed by camera device 200. In one example, first image capture device 212 and second image capture device 216 may be panned or tilted independently of one another, allowing each to capture image data representing a different portion of the environment. Alternatively, in some implementations, image capture devices 212 and 216 might not be independently repositionable.

Encoder(s) 228 may be configured to keep track an angular position of first image capture device 212, second image capture device 216, or components thereof relative to a fixed reference point, thereby allowing the tilt angles or pan angles of first image capture device 212 and second image capture device 216 to be determined and accurately adjusted using motors 224 and 226. Encoder(s) 228 may thus be referred to as absolute rotary encoders. Encoder(s) 228 may be conductive encoders, optical encoders, mechanical encoders, or magnetic encoders, among other possibilities.

Camera device 200 may additionally include inertial measurement units (IMUs) (not shown), including gyroscopes, accelerometers, and magnetometers, to assist with determining the position and orientation of camera device 200 or the components thereof. Camera device 200 may further include one or more illumination devices. The illumination devices may be configured to illuminate, by way of one or more LEDs for example, a scene to be filmed. Additionally or alternatively, the illumination devices may be configured to project a structured light pattern onto the environment to allow camera device 200 to determine a distance between itself and objects within the environment using active stereo vision or a form of computer vision.

Camera 200 may be configured to detect and cancel noise generated by motion system 220 so that this noise is not included in any captured audio data. Noise of motion system 220 may be cancelled by detecting the noise and generating, by way of one or more microphones in camera device 200, sound configured to destructively interfere with the noise. Alternatively, the noise may be removed from any captured audio by processing the captured audio using one or more signal processing techniques or algorithms.

Communication interface 202 of camera device 200 may be used to communicate with wireless tag(s) 230 by way of wireless link 2-4 and with viewing device(s) 232 by way of wireless link 236. Viewing device(s) 232 may be computing devices (such as, e.g., computing device 100) configured to receive, from camera device 200, transmission of captured photo or video content. In response to reception of the captured content, viewing device(s) 232 may be configured to display the content. Viewing device(s) 232 may also be configured to transmit to camera device 200, instructions to control or modify operation of camera device 200 (e.g., cause camera device 200 to tilt or pan to capture different content).

Wireless tag(s) 230 may be configured to be worn by one or more targets (e.g., mobile humans or inanimate objects such as sports balls) to be filmed by camera device 200. Each respective wireless tag of wireless tag(s) 230 may be configured to provide data indicative of a location of the respective wireless tag. The data indicative of the location of the respective wireless tag may be indicative of absolute location (i.e., defined in the Earth's frame of reference) or relative location (i.e., defined relative to camera device 200). The location of the respective wireless tag may be determined using GPS, differential GPS (DGPS), Wi-Fi triangulation, cellular base station triangulation, triangulation using near-field communication (NFC) beacons, radio-frequency identification (RFID), visible light communication systems (e.g., Li-Fi), infrared (IR) light, BLUETOOTH®, or based on gain of two or more directional antennas, for example.

Wireless tag(s) 230 may utilize external signal boosters (e.g., a phone or wireless beacon) to extend the range over which wireless tag(s) 230 can transmit and receive signals from camera device 200. Wireless tag(s) 230 and the signal boosters may be arranged in a mesh network topology, for example. Wireless tag(s) 230 may additionally include one or more IMUs, data from which may be used as an alternative indication of changes in position of wireless tag(s) 230. Wireless tag(s) 230 may also include additional sensors, such as heart rate sensors, respiration sensors, electromyography (EMG) sensors, among other possibilities, to monitor the physiological and kinematic parameters. These sensors may be integrated with wireless tag(s) 230, or may be provided separately to be disposed on or attached to a different part of a user's body. The additional sensors may be communicatively connected to wireless tag(s) 230. Data from the additional sensors may be transmitted to camera device 200 during filming along with data indicating a location of wireless tag(s) 230. Alternatively, the data from the additional sensors may be stored on wireless tag(s) 230 and may be uploaded to camera device 200 after filming (e.g., when wireless tag(s) 230 are connected to camera device 200 via a wired connection or when wireless tag(s) 230 come within a threshold range of camera device 200, thereby conserving a battery life of the wireless tag(s) 230).

Camera device 200 may be configured to reposition, using motion system 220, first image capture device 212 and second image capture device 216 to point them towards one or more of wireless tag(s) 230 based on the direction of the one or more wireless tag(s) 230 in relation to camera device 200. In implementations using two or more directional antennas to determine relative direction, for example, each of the two or more directional antennas may be pointed in a different direction and configured to receive a signal transmitted by wireless tag(s) 230. At least one of the two or more directional antennas may be radially aligned with first image capture device 212, for example. Thus, a power of the signal received by this antenna from a wireless tag may be highest when first image capture device 212 is pointed directly at the wireless tag. Camera device 200 may thus be configured to follow the one or more of wireless tag(s) 230 by turning in a direction that increases or maximizes the signal power received by the directional antenna aligned with first image capture device 212.

The direction in which to turn may be determined based on signal fluctuations measured by other antennas of the two or more directional antennas. For example, if another antenna to the right of the antenna aligned with first image capture device 212 detects an increase in the received power, this may indicate that the wireless tag being tracked moved towards the right, and first image capture device 212 should thus be panned right to follow the target wearing the wireless tag. Similarly, if the another antenna to the right of the antenna aligned with first image capture device 212 detects a decrease in the received power, this may indicate that the wireless tag being tracked moved towards the left, and first image capture device 212 should thus be panned left to follow the target wearing the wireless tag. Tracking of the wireless target may become more accurate as the number of directional antennas increases.

In implementations relying on IR light emitting diodes included on wireless tag(s) 230, wireless tag(s) 230 may be tracked using computer vision. Image data including the IR light emitted by wireless tag(s) 230 may be captured using an IR image capture device (not shown) on camera device 200. One or more computer vision algorithms may be used to detect and track wireless tag(s) 230 based on the captured IR image data. Camera device 200 may be panned or tilted to keep the IR light from wireless tag(s) 230 within a predetermined portion of the captured image data. For example, camera device 200 may be panned or tilted to keep a wireless tag at or near a center of the field of view of the IR camera, thereby following the movements of the wireless tag.

In an example embodiment, camera device 200 may be configured to capture video at a frame rate of 24 frames per second or higher, thereby allowing the IR LEDs of wireless tag(s) 230 to transmit (e.g., blink) up to 12 times per second (in view of the Nyquist-Shannon sampling theorem). Thus, up to 2¹²−1 distinct wireless tags may be encoded and disambiguated by assigning each wireless tag a distinct blinking pattern (i.e., wireless tag identification (ID)). The combination 000000000000 might not be used since the absence of blinking is not observable. Notably, the wireless tag IDs may be assigned to provide a wide margin of error in detection of the blinking pattern. That is, rather than assigning the first wireless tag the ID 000000000001, the second wireless tag the ID 000000000010, and so on (where 0 represents the LED in the off state and 1 represents the LED in the on state during a corresponding 1/12 of a second interval), the first wireless tag may be assigned ID 111111111111, the second wireless tag may be assigned ID 000000111111, the third wireless tag may be assigned ID 000111000111, the fourth wireless tag may be assigned ID 111000111000, and so on. The different wireless tags may be synchronized to a shared clock to use the above encoding scheme.

Alternatively, when the wireless tags are not synchronized to a shared clock, up to 12 different wireless tags may be encoded by measuring the duration that the LED of a given wireless tag remains turned on. For example, the first wireless tag may illuminate its LED for 1/12 of a second, the second wireless tag may illuminate its LED for 2/12 of a second, the third wireless tag may illuminate its LED for 3/12 of a second, and so on. The wireless tags may thus be identified and disambiguated without being synchronized to a shared clock. Notably, the intensity with which the IR LEDs emit IR light may be changed depending on ambient lighting conditions (e.g., intensity may be increased during daylight and decreased during nighttime). Additional encoding capacity may be added by including additional LEDs operating in different portions of the IR spectrum (along with corresponding IR detectors on camera device 200).

IV. Example Camera Form Factor and Housing

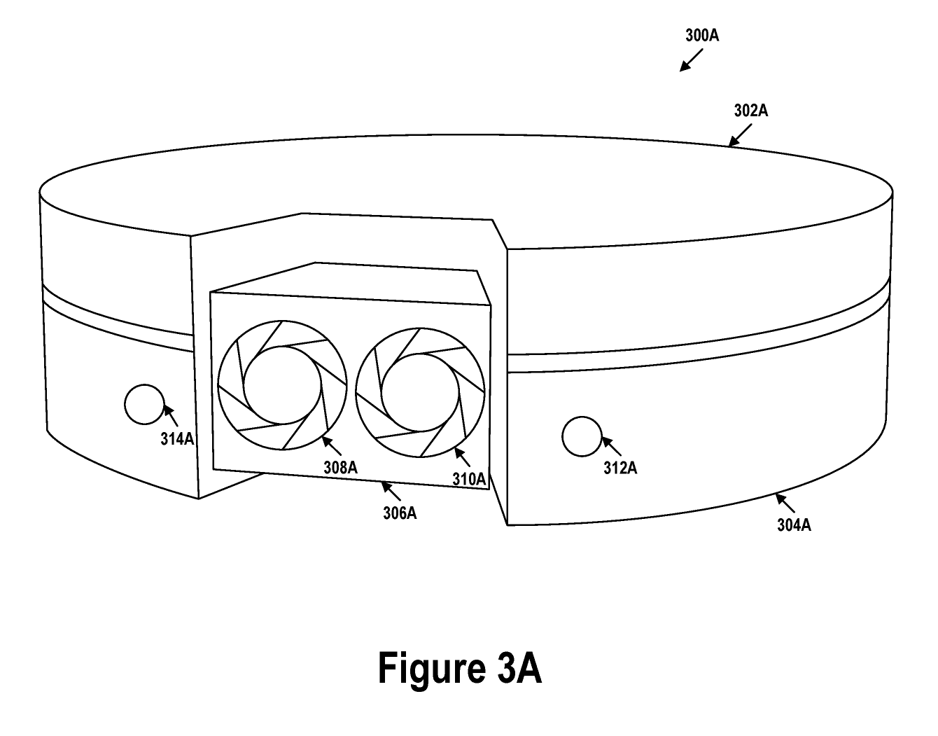

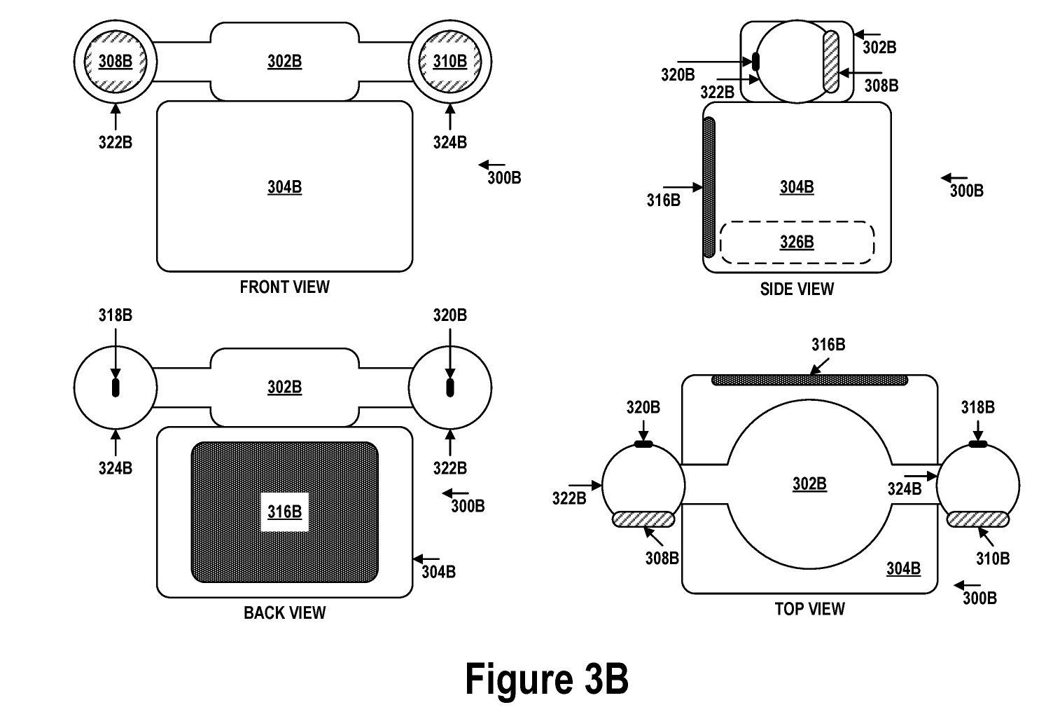

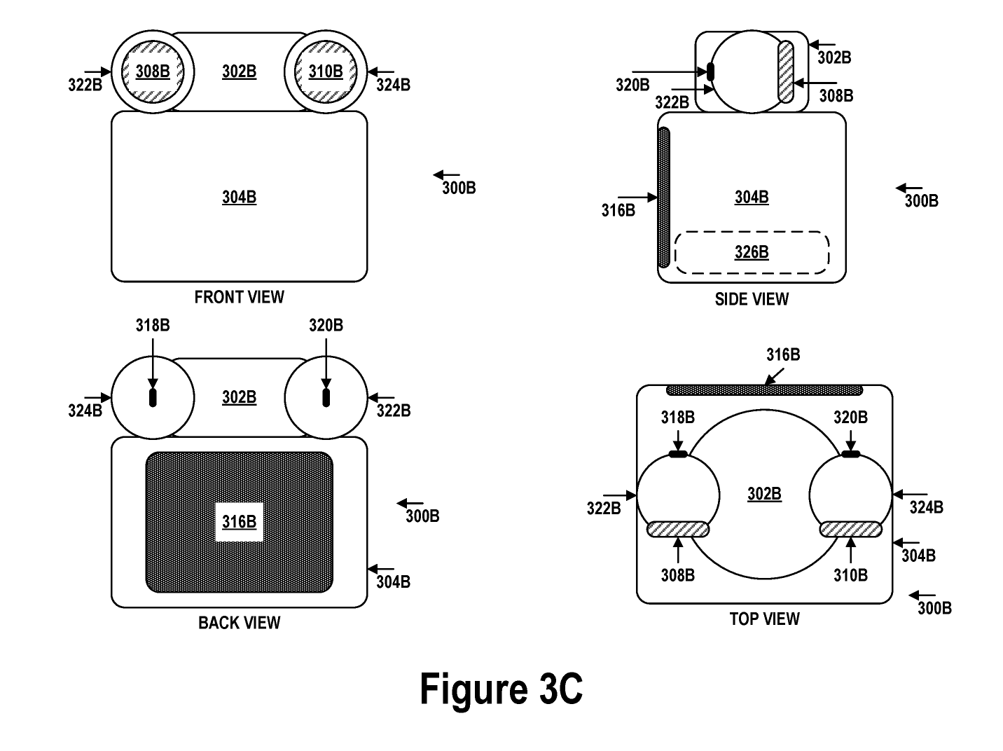

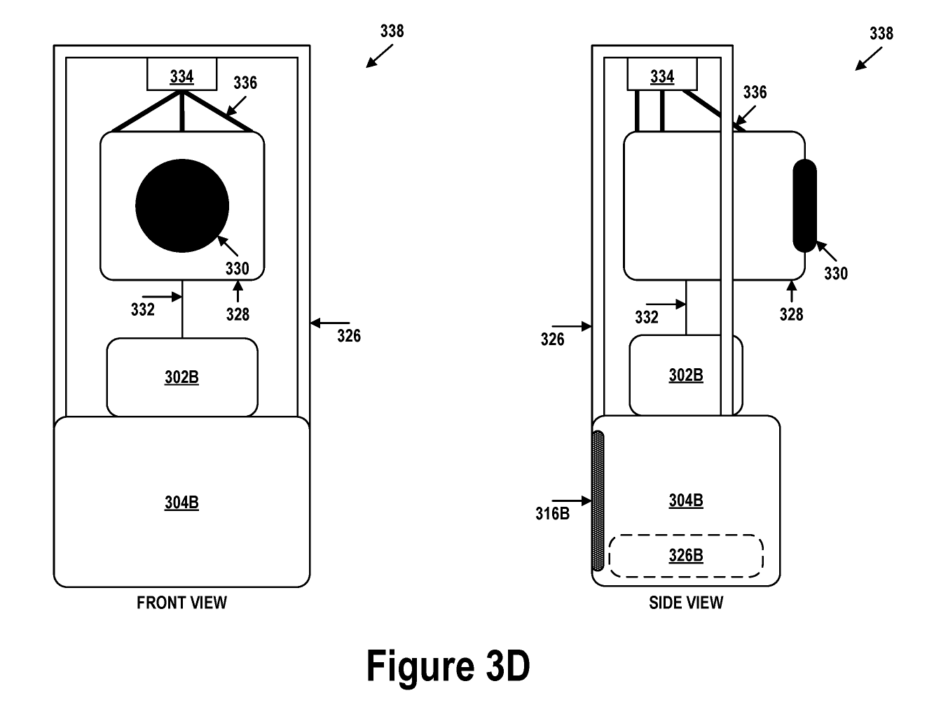

FIG. 3A illustrates an example form factor of camera device 200. Namely, components of camera device 200 may be enclosed in housing 300A. Housing 300A may be shaped like a puck or cylinder. However, housing 300A may also take on other shapes, such as a rectangular prism, for example. Housing 300A may include a top housing portion 302A and a bottom portion 304A, with components of camera device 200 encased therebetween. Top housing portion 302A and bottom housing portion 304A may be removably attachable or lockable to one another. When attached or locked, top and bottom housing portions 302A and 304A, respectively, may form a water-tight seal to protect the components of camera device 200 housed therebetween. When detached, housing portions 302A and 304A may allow for access to the internal components of camera device 200, allowing for, for example, changes of battery or storage devices.

Housing 300A may also include apertures 308A and 310A disposed within portion 306A of housing 300A. Apertures 308A and 310A may provide a path for light from the environment to reach lens(es) 213 and 217 and thus image sensors 214 and 218, respectively. In some embodiments, apertures 308A and 310A may be positioned one on top of the other, rather than side-by-side as shown. Other aperture arrangements are possible. Housing 300A may additionally include embedded therein buttons 312A and 314A (e.g., power buttons, start/stop buttons, etc.) which may form part of user interface 204 of camera device 200. Housing 300A may further include a viewfinder (not shown) positioned opposite to apertures 308A and 310A, or a display (not shown) configured to display the content captured by image sensors 214 and 218.

Housing 300A may provide thereon one or more mechanical connection points (e.g., 0.25 inch tripod screw or socket) configured to connect housing 300A to camera support structures such as tripods, gimbal camera mounts, zip line camera mounts, robot camera mounts, head camera mounts, suction mounts, or other stationary and action camera mounts. Housing 300A may additionally provide electromechanical connection points (e.g., a hot shoe mount) allowing for the addition of various peripherals to the camera device, including boom microphones, additional batteries, lighting devices, solar charging panels, additional lenses or lens systems displays, or speakers, among other possibilities.

FIGS. 3B and 3C illustrate front, side, back, and top views of an alternative form factor of camera device 200. Components of camera device 200 may be enclosed in housing 300B, which includes top housing portion 302B and bottom housing portion 304B. Top housing portion 302B may have a cylindrical shape and may include telescopic arms connected thereto at diametrically opposite points of top housing portion 302B. Bottom housing portion 304B may be a rectangular prism (e.g., a cube). Apertures 308B and 310B may be housed in housing portions 322B and 324B, respectively, which may have an “eyeball” shape or a cylindrical shape, among other possibilities. Eyeballs 322B and 324B may be connected to top portion 302B by way of the telescopic arms, which are shown extended in FIG. 3B and retracted in FIG. 3C. In the orientation shown in FIG. 3B, the camera device may be configured for data capture. In the orientation shown in FIG. 3C, the camera device may be configured for storage due to its smaller and more compact shape.

Eyeballs 322B and 324B may also include therein lens(es) 213 and 2117 and image sensors 214 and 218, respectively. Eyeballs 322B and 324B may additionally house therein memory cards 318B and 320B configured to store image data generated by image sensors 214 and 218, respectively. Bottom portion 304B may include therein a battery compartment 326B, which may contain therein one or more hot-swappable batteries. Bottom portion 304B may also include display 316B which may be configured to display data captured by the camera device and to control operation of the camera device, among other possible functions. Housing 300B may additionally include aspects of housing 300A, such as buttons and electromechanical connection points, not shown in FIGS. 3B and 3C. Additionally, in some implementations, additional “eyeballs,” including therein corresponding apertures, lenses, and image sensors, may be connected to top portion 302B. Further, eyeballs 322B and 324B (as well as the image capture devices associated with apertures 308A and 310A) may be removably connectable to top housing portion 302B or to the telescopic arms, thereby allowing for different image capture devices (e.g., camera phone, digital single-lens reflex (DSLR) camera, broadcast TV camera, etc.) to be used in place of eyeballs 322B and 324B. Mechanical and electrical couplings may be provided on the housing 300A or 300B to allow for connecting a wide range of different types of image capture devices to the housing.

FIG. 3D illustrates front and side views of another form factor 338 of camera device 200. In form factor 338, camera system 200 may be configured to receive an analog or digital input from an external image capture device and control a gimbal-like device (to which the external image capture device is mechanically coupled) to keep a target within the field of view of the external image capture device. Form factor 338 may be referred to as a yoke or gimbal, among other possibilities.

Form factor 338 may include bottom housing portion 304B, top housing portion 302B, and suspension structure 326 connected to bottom housing portion 304B. Image capture device 328 (having aperture/lens 330) may be suspended from suspension structure 326 by a plurality of linkages 336. Image capture device 328 may be removably attachable to linkages 336 to allow for a wide variety of external image capture devices to be connected to support structure 326. Linkages 336 may be mechanically coupled to motors 334 which may be configured to actuate the linkages to pan, tilt, and otherwise reposition image capture device 328 to film different portions of the environment and track different targets. Support structure 326 may also include various gyroscopes connected to motors 334 and linkages 336 to stabilize image capture device 228. Image capture device 328 may be communicatively connected to housing portions 302B and 304B (which may house the control system of camera device 200) by way of connection 332. In some implementations, additional image capture devices may be connected to support structure 326. Camera system 200, in the form factor shown in FIG. 3D, may be configured to perform any of the operations herein described.

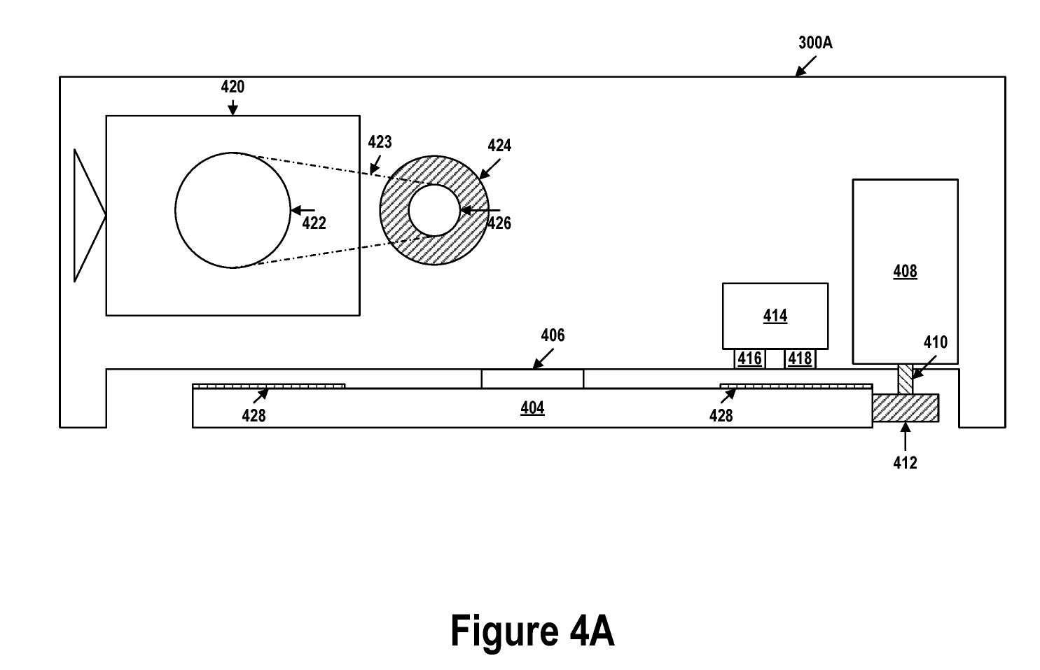

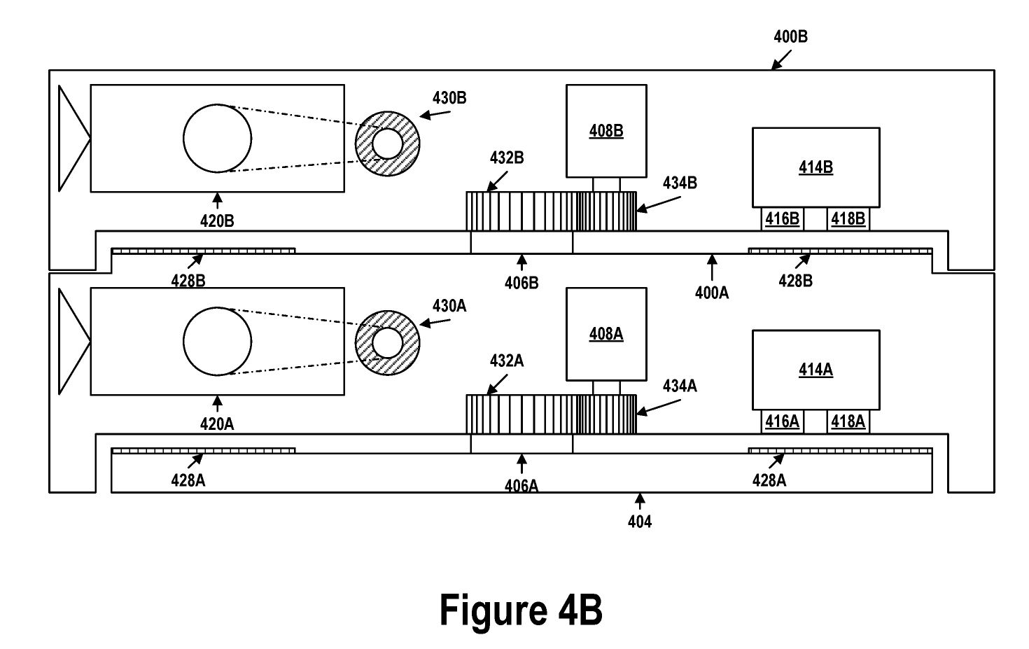

FIG. 4A illustrates a side cross-section view of camera device 200 implemented in the form factor shown in FIG. 3A. FIG. 4A shows housing 300A, imaging unit 420, pulleys 422 and 426, belt 423, motors 424 and 408, encoder 414, light emitting device (LED) 416, photodiode 418, encoder markings 428, motor shaft 410, friction wheel 412, base plate 404, and rotational joint 406. Housing 300A may be pivotably connected to base plate 404 by way of rotational joint 406. Base plate 404 may include on a bottom face thereof a threaded opening, a screw, or other coupling mechanism or fastener configured to connect base plate 404 to a tripod or other camera support stand. When housing 300A is cylindrical, base plate 404 may likewise have a cylindrical shape and be disposed within a cylindrical recess in the bottom of housing 300A, as shown.

Motor 408 may be disposed within and connected to housing 300A. Motor 408 may be connected to friction wheel 412 by way of motor shaft 410. Friction wheel 412 may be positioned in direct contact with base plate 404. In some implementations, friction wheel 412 may be biased or otherwise pushed to maintain contact with base plate 404 using a spring or similar biasing mechanism. Thus, motor 408, which may be one of pan motor(s) 226, may be used to rotate (i.e., pan) housing 300A, and all the components therein, with respect to base plate 404.

This mechanism for driving housing 300A relative to base plate 404 may be referred to as a friction drive mechanism. Alternatively or additionally, some embodiments may utilize a belt drive mechanism, a gearbox a frictionless drive, or a direct drive among other possibilities. A belt drive, for example, may involve a first pulley disposed about motor shaft 410 driving, by way of a belt (e.g., rubber belt), a second pulley disposed about the shaft of rotational joint 406.

Encoder 414 may be configured to monitor the angular position of housing 300A with respect to base plate 404. LED 416 of encoder 414 may emit light towards encoder markings 428 disposed on base plate 404. The light emitted by LED 416 may be reflected from encoder markings 428 and thereafter detected by photodiode 418, causing photodiode 418 to generate an electric current which varies based on the position-dependent pattern of encoder markings 428. The electric current generated by photodiode 418 may be used to determine the position of housing 300A in relation to base plate 404. Accordingly, encoder 414 may generate data indicative of a position of housing 300A in relation to base plate 404, allowing motor 408 to, using negative feedback, accurately move housing 300A to desired positions, at desired velocities, or with desired accelerations. Other technologies may also be used instead or additionally.

Imaging unit 420 may house components of first image capture device 212 and second image capture device 216 and may be fixedly connected to housing 300A. Thus, as housing 300A is panned relative to base plate 404, imaging unit 420 may also be panned to reposition the fields of view of first image capture device 212 and second image capture device 216 horizontally onto different portions of the environment. Housing 300A may be rotatable by 360 degrees or more with respect to base plate 404. Thus, imaging unit 420 may be configured to capture image data representative of the entire 360-degree expanse of the environment surrounding housing 300A. However, in alternative embodiments, housing 300A may also be rotatable by less than 360 degrees with respect to base plate 404. Additionally, in some implementations, instead of housing 300A being rotatable with respect to base plate 404, imaging unit 420 may instead be rotatable with respect to housing 300A to control the portion of the environment observed by imaging unit 420.

Imaging unit 420 may include various mechanical support structures, including Printed Circuit Boards (PCBs), arranged to create an optical path between the environment, lens(es) 213, and main image sensors 214, as well as between the environment, lens(es) 217, and wide-angle image sensors 218. Imaging unit 420 may be pivotably connected within housing 300A in a way that allows imaging unit 420 to be tilted up and down with respect to housing 300A, thereby repositioning the fields of view of first image capture device 212 and second image capture device 216 vertically onto different portions of the environment. Imaging unit 420 may have a tilt range of, for example, 180 degrees or greater, allowing imaging unit 420 to be tilted from facing left, as shown, by 180 degrees to face right. To that end, imaging unit 420 may be centered within housing 300A, which may be configured to allow the aperture of imaging unit 420 an unobstructed view on both the left and right sides, as shown, of housing 300A.

Imaging unit 420 may be connected to pulley 422 which may in turn be connected to pulley 426 by way of belt 423. Pulley 426 may be disposed about a shaft of motor 424. Thus, imaging unit 420 may be tilted up or down by actuating motor 424. Clockwise rotation of motor 424 and pulley 426 may cause imaging unit 420 to tilt downwards, while counterclockwise rotation of motor 424 and pulley 426 may cause imaging unit 420 to tilt upwards. In some implementations, imaging unit may be driven by motor 424 by way of a friction drive, a gearbox, or a direct drive, rather than through pulleys 422 and 426 and belt 423.

In some embodiments, housing 300A may include therein multiple imaging units 420. A first unit may include therein first image capture device 212. A plurality of additional imaging units may be included disposed at different points about the circumference of housing 300A. Each of the plurality of additional imaging units may include therein a corresponding second image capture device 216. The number of the plurality of additional imaging units may be such that the collective extent of the fields of view of the additional image capture devices spans the entire horizontal 360 degree expanse about housing 300A. Thus, data from the multiple image capture devices may represent the entire horizontal expanse around the camera device, allowing the camera device to monitor this expanse for features of interest without having to pan and without having to change the portion of the environment filmed by first image capture device 212.

In another example implementation, the components shown in FIG. 4A may be adapted (i.e., spatially arranged) to the form factor shown in FIGS. 3B and 3C. Thus, one instance of imaging unit 420 (containing a corresponding image sensor and lens(es)) may be housed in each of eyeballs 322B and 324B. Eyeballs 322B and 324B may be panned and tilted by way of motors 408 and 424, respectively, along with their corresponding drive mechanisms. Notably, motor 424 may be configured to tilt eyeballs 322B and 324B indirectly, by rotating the telescopic arms by way of which eyeballs 322B and 324B are connected to top housing portion 302B. In some implementations, additional motors may be included to allow eyeballs 322B and 324B to be tilted independently of one another. Top housing portion 302B may be connected to bottom housing portion 304B by way of rotational joint 406, and the relative position of top and bottom housing portions 302B and 304B may be monitored based on data from encoder 414.

FIG. 4B illustrates a side cross-section view of an alternative arrangement of the components of camera device 200 within housing 300A. Specifically, housing 300A may include a top housing portion 400B and a bottom housing portion 400A, which may correspond to portions 302A and 304A in FIG. 3. Bottom housing portion 400A may be rotatably connected to base plate 404 by way of rotational joint 406A, while top housing portion 400B may be rotatably connected to bottom housing portion 400A by way of rotational joint 406B. Thus, bottom housing portion 400A and top housing portion 400B may be rotatable relative to base plate 404 independently of one another.

Bottom housing portion 400A may include therein first imaging unit 420A, which may house first image capture device 212. Similarly, top housing portion 400B may include therein second imaging unit 420B which may house second image capture device 216. Accordingly, first imaging unit 420A and second imaging unit 420B may be rotatable relative to base plate 404 independently of one another. Imaging units 420A and 420B may therefore be controlled to capture image data representing the same or different portion of the environment. Thus, data from the wide-angle image capture devices may be used to monitor the horizontal expanse around the camera device for features of interest without having to change the portion of the environment filmed by first image capture device 212.

For example, the camera device may be used to capture a sporting event (e.g., soccer). First imaging unit 420A may be configured to track and film a particular player within the game, while second imaging unit 420B may be configured to follow the ball, another player of interest, or the referee, among other possibilities to identify events of interest taking place outside of the field of view of first imaging unit 420A. In some implementations, first imaging unit 420A may instead be included in top housing portion 400B and second imaging unit 420B may be included in bottom housing portion 400A.

Bottom housing portion 400A may include motor 408A configured to rotate bottom housing portion 400A with respect to base plate 404 by way of gears 432A and 434A. Similarly, top housing portion 400B may include motor 408B configured to rotate top housing portion 400B with respect to bottom housing portion 400A by way of gears 432B and 434B. However, in some embodiments, gears 432A, 434A, 432B, and 434B may be replaced by a friction drive, a belt drive, or a direct drive, among other possibilities. Each of imaging units 420A and 420B may be configured to tilt with respect to housing portions 400A and 400B, respectively, when driven by tilt mechanisms 430A and 430B, respectively, similar to the belt drive described with respect to FIG. 4A.

Bottom housing portion 400A may also include therein encoder 414A, which may include LED 416A and photodiode 418A. Encoder 414A may be configured to generate an electric current indicative of a rotational position, velocity, or acceleration of bottom housing portion 400A relative to base plate 404 based on encoder markings 428A. Similarly, top housing portion 400B may include therein encoder 414B, which may include LED 416B and photodiode 418B. Encoder 414B may be configured to generate an electric current indicative of a rotational position, velocity, or acceleration of top housing portion 400B relative to bottom housing portion 400A based on encoder markings 428B.

Additionally, in some implementations, the components shown in FIG. 4B may be adapted (i.e., spatially arranged) to the form factor shown in FIGS. 3B and 3C. Namely, base plate 404 may correspond to bottom housing portion 304B, bottom housing portion 400A may correspond to top housing portion 3028, and top housing portion 400B may correspond to an additional housing portion (not shown in FIGS. 3B and 3C) similar to top housing portion 302B and rotatably connected atop thereof. That is, housing portions 400B and 400A may represent two instances of top housing portion 302B (along with the telescoping arms and “eyes” connected thereto) stacked on top of one another.

V. Example Camera System Operations

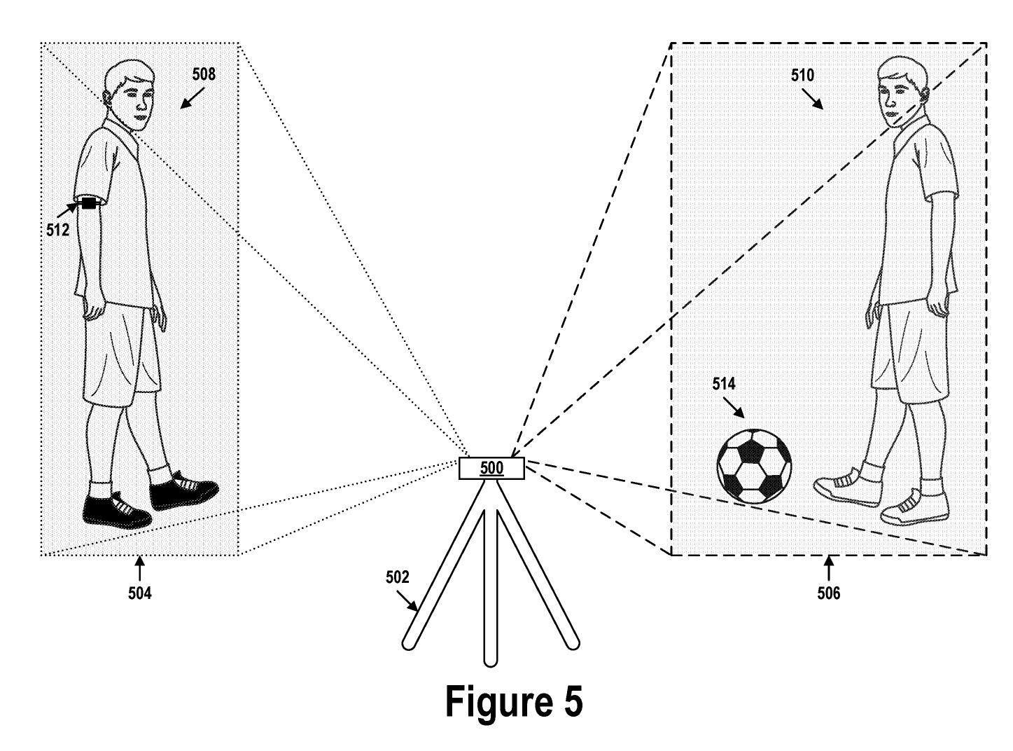

FIG. 5 illustrates camera device 500 being used to film scenes within an environment. Camera device 500 may be or may include components of camera device 200, which may be disposed within housing 300A or 300B, as described with respect to FIGS. 2-4B. Camera device 500 may be disposed on tripod 502 and may be used to film, for example, a sporting event such as a soccer game taking place within the environment. The soccer game may include a plurality of players, including player 508 and player 510, which are differentiated by the color of their shoes for clarity of illustration.

Player 508 may wear wireless tag 512 (i.e., one of wireless tag(s) 230) to facilitate tracking of player 508 by camera device 500. Accordingly, as indicated by field of view 504, camera device 500 may be configured to track and film player 508, among other players, during the sporting event using first image capture device 212. Notably, since wireless tag 512 is worn on the arm of player 508, the location data transmitted therefrom may be filtered using a low-pass filter before being used to control the pan or the of any image capture devices. The low-pass filter may remove high-frequency movements of the arm of player 508 from the overall movement of the body of player 508 through the environment. Camera device 500 may also be configured to track, based on data from second image sensor 218, player 510, ball 514, or one or more other players, features, or events of interest within the environment, as indicated by field of view 506. In some embodiments, player 510 or ball 514 may also be tracked based on signals from wireless tags attached thereto or contained therein, respectively.

Notably, in some implementations, second image capture device 216, and the lenses associated therewith, may provide a larger (e.g., wider) field of view than first image capture device 212. Thus, data from second image capture device 216 may represent a larger portion of the environment, and thus a larger number of objects or events of interest within the environment. This may be the case when the field of view captured by second image capture device 216 is fixed in relation to the field of view captured by first image capture device 212, as in the implementation of FIG. 4A, as well as when the fields of view are moveable with respect to one another, as in the implementation of FIG. 4B. Data from first image capture device 212, however, may be free of any distortion (e.g., barrel distortion) caused by any wide-angle lenses associated with second image sensor 218. Additionally, due to the smaller field of view, data from first image capture device 212 may also provide a higher resolution of features within the environment than data from second image sensor 218. Therefore, second image sensor 218 may be primarily dedicated to scanning the environment for objects or events of interest, while first image sensor 214 may be primarily dedicated to filming the objects or events of interest (although each may be used for both scanning and filming).

In alternative implementations, the relative sizes of the fields of view of the first and second image capture devices 212 and 216 may change as each image capture device is zoomed in or out. Accordingly, image data from the image capture device with a smaller field of view may be captured and used to track (e.g., tracking may be more accurate when using higher-resolution image data) a target of interest (e.g., player 508), while image data from the other image capture device (with the larger field of view) may be processed to monitor the environment for other features or events of interest. When the relative size of the fields of view changes due to the zoom of the image capture devices being adjusted, the image capture device used to track and film the target of interest may change as well.

In one example, first image capture device 212 may be primarily used to film player 508, while second image capture device 216 may be used to capture image data representative of portions of the environment outside of field of view 504. The data from second image capture device 216 may be used to monitor the environment for features or events of interest. For example, second image capture device 216 may be periodically repositioned to follow ball 514 since most of the action in the soccer game is likely to be centered around ball 514. When the data from second image capture device 216 does not contain features or events of interest, first image capture device 212 may be used to film player 508. However, when the data from second image capture device 216 contains features or events of interest, first image capture device 212 may be repositioned to film the features of events of interest, which might or might not include player 508. Camera device 500 may subsequently return to tracking and filming player 508, or may identify other features or events of interest which to film using first image capture device 212. Thus, camera device 500 may be configured to automatically switch between filming different portions of the sporting event based on the events taking place on the field. Camera device 500 may also be switched between filming the different portions of the sporting event manually. In some instances, second image capture device 216 may be used to monitor a static target such as a scoreboard while first image capture device 212 films player 508.

Features or events of interest may be identified within the image data from second image capture device 216 using one or more image processing or feature detection algorithms. The features detected within the image data may be filtered according to one or more context-specific algorithms to identify the features or events of interest. A context-specific algorithm may be predefined for the type of content being filmed by camera device 500, and may define sets of conditions that constitute features or events of interest. Context-specific algorithms may be specific to different types of sports (e.g., soccer, football, baseball, basketball, snowboarding, boxing, etc.), for example. In the case of a soccer-specific algorithm, for example, an event of interest may be defined by ball 514 coming within or appearing to come within a threshold distance of the goal post. In the case of a hockey-specific algorithm, an event of interest may be defined by two players colliding together. In some implementations, features or events of interest may be identified by way of one or more computer vision or machine learning algorithms such as, for example, artificial neural networks or k-nearest neighbors, which may be configured or trained using sports-specific training data.

In some embodiments, camera device 500 may be configured to communicate with one or more other camera devices disposed within the environment. The communication may take place, for example, over a mesh network implemented using Wi-Fi or BLUETOOTH®, among other possible physical layers. For example, camera device 500 and the other camera device may each be disposed on the sidelines of a sporting event. Camera 500 may be configured to receive, from the other camera, image data captured by either the first image capture device or the second (e.g., wide-angle) image capture device of the other camera. Based on the image data from the other camera, the position of the other camera, and image data captured by camera 500, camera device 500 may be configured to determine which portion of the environment to film with first image capture device 212 or second image capture device 216. Due to having a different perspective of the field, the other camera may be able to detect features or events of interest that might not be visible to camera device 500 (e.g., due to occlusion by players or referees). Thus, imaging systems of camera device 500 may be positioned to capture the features or events of interest before the features or events of interest would otherwise be detected by camera device 500 (e.g., when any obstructions or occlusions are removed).

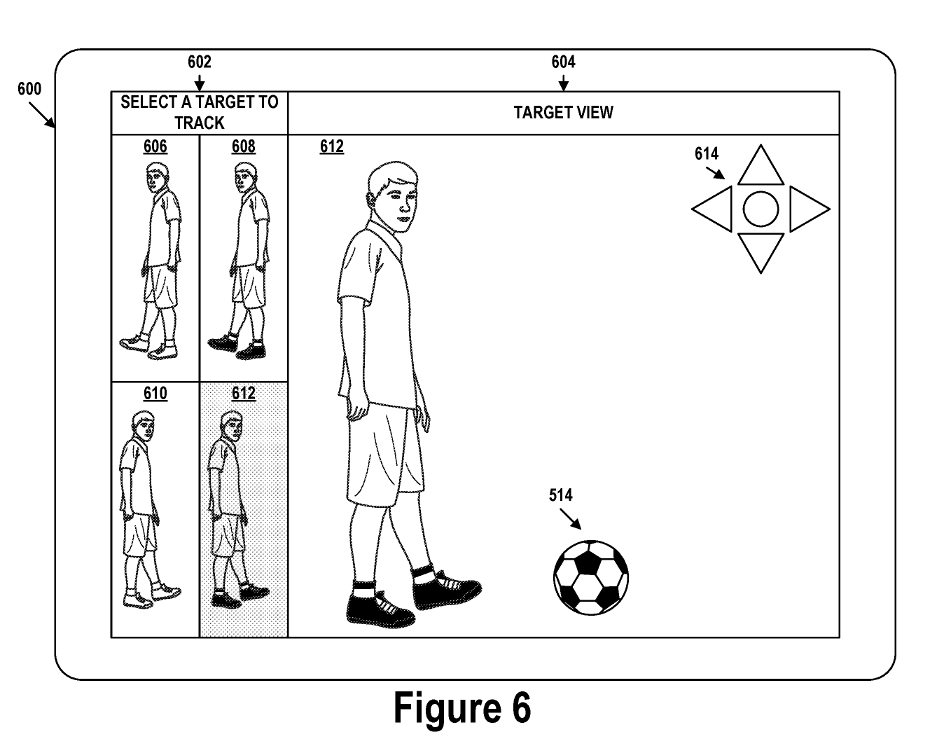

FIG. 6 illustrates an example user interface of viewing device 600 that may be used to control the content captured or streamed by camera device 200 or 500. Viewing device 600, illustrated as a tablet computer, may be one of viewing device(s) 232 shown in FIG. 2. A user may interact with the user interface by way of touch inputs, voice inputs, or inputs from a peripheral device such as a mouse, keyboard, or trackpad, among other possibilities. Viewing device 600 may alternatively be referred to as a control device of camera device 500.

The user interface may include a target selection portion 602 and a target view portion 604. Target selection portion 602 may display a plurality of targets 606, 608, 610, and 612 (i.e., targets 606-612) located in the environment surrounding camera device 500. Targets 606-612 may be, for example, athletes playing a game of soccer and may be identified based on data from second image sensor 218 or wireless tag(s) 230. Each of targets 606-612 may be selectable by way of target selection portion 602 to control the content displayed by target viewing portion 604. For example, target 612 may be selected, as indicated by the shading of the corresponding region of target selection portion 602, and may thus be displayed in target view portion 604. A target may be selected manually, based on input received by way of the user interface of viewing device 600, or automatically, based on, for example, which of targets 606-612 is currently exhibiting a level of activity greater than a threshold value or greater than the other targets (e.g., is in possession of the ball). In some embodiments, when multiple camera units are distributed around the field to film the game, the user interface may also allow for selection of one of the multiple cameras from which to stream footage of the selected target or for simultaneous streaming of the same footage from different perspectives.

The user interface may also include directional pad 614, allowing for manual control over the pan and tilt angle of camera device 500. Directional pad 614 may be used to override the tracking of a specific target, allowing the pan and tilt angle of the imaging units in camera device 500 to be completely controlled by way of input received by the user interface. Alternatively, directional pad 614 may be used in combination with the tracking of the specific target, allowing the target view to be adjusted around the tracked target by way of input received by the user interface.

Additionally, selection of a target from target selection portion 602 may control the content captured by first image capture device 212. Selecting a target from target selection portion 602 may cause viewing device 600 to transmit, to camera device 500, instructions to track and film the selected target using first image capture device 212. In response to reception of these instructions, camera device 500 may initiate tracking of the selected target and filming of the selected target by way of first image capture device 212. The selected target may be tracked based on a wireless tag worn by the selected target or based on feature recognition and tracking carried out on image data received from first image capture device 212 or second image capture device 216. In some implementations, the selected target may also be tracked and filmed by one or more of wide-angle image capture devices 216.

The user interface of viewing device 600 may also be used to control a plurality of parameters or settings of camera device 500. The values to which parameters of camera device 500 are set may determine or influence a quality of the image data captured by camera device 500 (e.g., sharpness, noise, dynamic range, tone reproduction, contrast, color accuracy, distortion, lateral chromatic aberration, artifacts, etc.). The parameters may include a level of magnification or zoom of the captured content, a frame rate of the image sensors, a resolution of data captured by the image sensors, a white balance of the captured content, or an exposure time of the image sensors, among other parameters.

Further, camera device 500 may be associated with a software application for viewing, managing, and editing the footage captured by camera device 500. The software application may include the user interface shown and described with respect to FIG. 6, as well as the functionality associated therewith. The software application may be a web-based application or an application executed locally by a computing device on which the user interfaces of the software application are displayed. Camera device 500 may be configured to transmit the footage it captures to the software application or to a remote storage location from which the software application can access the data.

The software application may be configured to parse and identify, in the footage uploaded from camera device 500, footage portions or sections that include content of interest (e.g., game highlights). The software application may utilize one or more computer vision, speech recognition, artificial intelligence, or machine learning algorithms to identify the content of interest, as well as determine parameters associated with the content of interest (e.g., game score, player score, various player achievements, etc.). The algorithms may be programmed, trained, or adapted to identify content of interest in a context-specific manner. That is, a soccer game may be analyzed using soccer-specific algorithms configured to identify content that is of interest in a soccer game, but might not be of interest in another sport. The software application may additionally be configured to generate, based on the content of interest, highlight reels (i.e., shortened versions of all the content captured by camera device 500 within a particular time window, emphasizing content of interest and omitting content lacking notable events). The software application may be configured to resize, frame, change the color of, or zoom in on portions of the highlight reel to further emphasize the content of interest. The highlight reel may be generated to have a length or size adapted to allow the highlight reel to be shared by way of one or more social media platforms or video sharing platforms.

In some embodiments, camera device 500 may be used to capture footage of an individual performing one or more predetermined physical movements, such as exercises or sports drills. The software application may, in turn, be used to evaluate the quality of the one or more predetermined physical movements by, for example, comparing the recorded physical movements against similar reference movements performed by a professional athlete or a trainer, for example. The reference movements may be associated with measurements of speed, position, and angle of various portions of the body of the athlete or trainer, as well as measurements indicating the exertion level (e.g., heart rate, breathing rate, etc.) of the athlete or trainer. Notably, the captured physical movements and the reference movements may be performed and recorded with the performers positioned at approximately the same location relative to camera device 500 (e.g., within several centimeters thereof), thereby allowing for direct comparison of the video footage, as well as the measurements indicating exertion level. The software application may be used to determine and indicate differences in timing of the physical movements as well as differences in limb angles of the performers, for example.

VI. Additional Example Operations

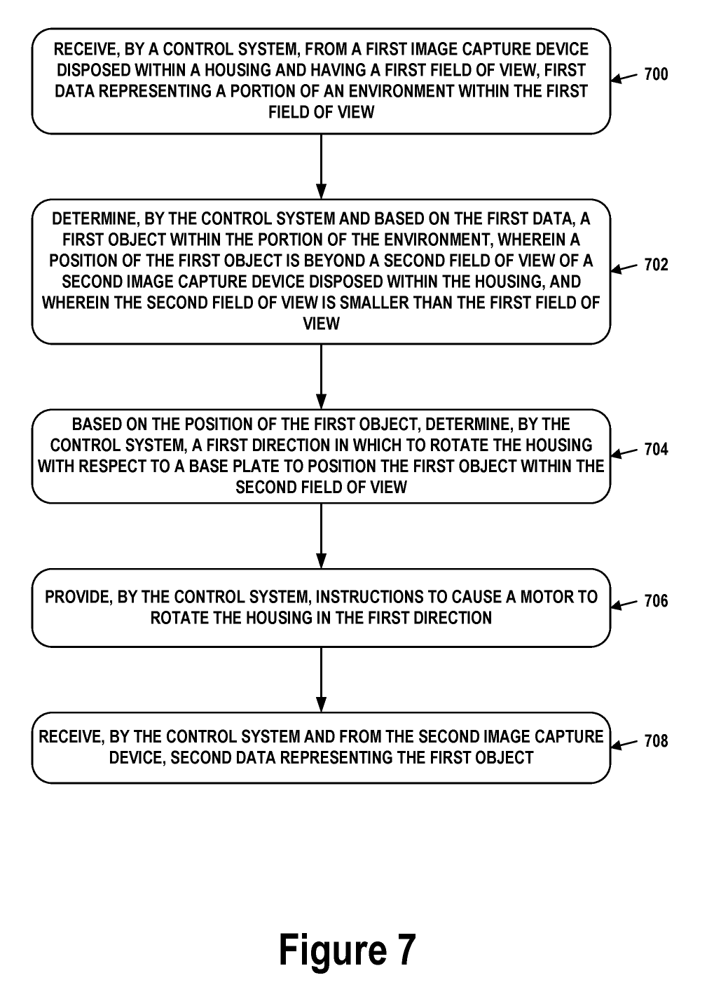

FIG. 7 is a flow chart illustrating an example embodiment. The process illustrated by FIG. 7 may be carried out by a camera device, such as camera device 200 or camera device 500. However, the process can be carried out by other types of devices or device subsystems. For example, the process could be carried out by a computing device remote to a camera device, such as computing device 100 or viewing device 600.

The embodiments of FIG. 7 may be simplified by the removal of any one or more of the features shown therein. Further, these embodiments may be combined with features, aspects, and/or implementations of any of the previous figures or otherwise described herein.

Block 700 may involve receiving, by a control system, from a first image capture device disposed within a housing and having a first field of view, first data representing a portion of an environment within the first field of view.

Block 702 may involve determining, by the control system and based on the first data, a first object within the portion of the environment. A position of the first object may be beyond a second field of view of a second image capture device disposed within the housing. The second field of view may be smaller than the first field of view.

Block 704 may involve, based on the position of the first object, determining, by the control system, a first direction in which to rotate the housing with respect to a base plate to position the first object within the second field of view.

Block 706 may involve providing, by the control system, instructions to cause a motor to rotate the housing in the first direction.

Block 708 may involve receiving, by the control system and from the second image capture device, second data representing the first object.

In some embodiments, the housing may include a first housing portion coaxial with and rotatable independently of a second housing portion. The first image capture device may be disposed within the first housing portion. The second image capture device may be disposed within the second housing portion. A second motor may be configured to rotate the first housing portion with respect to the second housing portion. Determining the first direction in which to rotate the housing to position the first object within the second field of view may involve, based on an angular position of the first housing portion in relation to the second housing portion, determining an angular displacement by which to rotate the second housing portion to position the first object within the second field of view. Providing the instructions to cause the motor to rotate the housing in the first direction may involve providing instructions to cause the second motor to rotate the second housing with respect to the first housing portion in the first direction by the angular displacement.

In some embodiments, the first field of view may overlap with the second field of view. The first image capture device may be disposed within the housing in a fixed position in relation to the second image capture device.

In some embodiments, the housing may be a cylindrical housing including in a bottom thereof a cylindrical recess. The base plate may be a cylindrical plate disposed within the cylindrical recess.

In some embodiments, rotating the housing with respect to the base plate may control a horizontal position of the first field of view and the second field of view. A second motor may be configured to rotate at least one of the first image capture device or the second image capture device with respect to the housing to control a vertical position of at least one of the first field of view or the second field of view, respectively.

In some embodiments, a position encoder may be disposed within the housing and configured to generate a signal indicative of an angular position of the housing with respect to the base plate. Determining the first direction in which to rotate the housing to position the first object within the second field of view may involve receiving the signal from the position encoder and, based on the signal from the position encoder, determining an angular displacement by which to rotate the housing in the first direction to position the first object within the second field of view. Providing the instructions to cause the motor to rotate the housing in the first direction may involve, based on the signal from the position encoder, providing instructions to cause the motor to rotate the housing with respect to the base plate in the first direction by the angular displacement.

In some embodiments, determining the first object within the portion of the environment may involve determining, based on the first data, a plurality of objects within the portion of the environment. The plurality of objects may include the first object. The control system may be configured to transmit, to a computing device, image data representing each of the plurality of objects. Reception of the image data may cause the computing device to display, in a first portion of a user interface, visual representations of the plurality of objects. The control system may additionally be configured to receive, from the computing device, a selection of the first object. The control system may further be configured to, in response to receiving the selection of the first object, transmit, to the computing device, the second data. The second data may include a video stream. Reception of the second data may cause the computing device to display, in a second portion of the user interface, the video stream.

In some embodiments, the control system may be configured to receive, from a computing device, instructions to reposition at least one of the first field of view or the second field of view in a second direction relative to the environment. The control system may additionally be configured to, in response to receiving the instructions, provide instructions to cause the motor to rotate the housing in the second direction.

In some embodiments, the base plate may include a fastener configured to mechanically couple the base plate to a camera support structure.

In some embodiments, a wireless tag may be communicatively connected to the control system and configured to transmit data indicative of a location of the wireless tag. Determining the first direction in which to rotate the housing to position the first object within the second field of view may involve receiving, from the wireless tag, data indicative of the location of the wireless tag. The wireless tag may be disposed on at least one object within the environment. The first direction in which to rotate the housing to position the first object within the second field of view may be determined further based on the data indicative of the location of the wireless tag.

In some embodiments, the first data may represent the portion of the environment from a first perspective. Determining the first direction in which to rotate the housing to position the first object within the second field of view may involve receiving, from a third image capture device disposed within a second housing, third data representing the first object from a second perspective different from the first perspective. The first direction in which to rotate the housing to position the first object within the second field of view may be determined further based on the third data.

In some embodiments, the position of the first object may be a first position of the first object within a first image represented by the first data. The first image capture device may he separated from the second image capture device by a first distance. The control system may also be configured to determine a second distance between the first object and at least one of the first image capture device or the second image capture device based on (i) the first distance, (ii) the first position, and (iii) a second position of the first object within a second image represented by the second data and corresponding to the first image. The control system may additionally be configured to, based on the second distance, adjust values of one or more parameters of the second image capture device to modify an image quality of the second data.

In some embodiments, the housing may include a cylindrical body rotatably coupled to a base plate. The housing may also include a first telescopic portion configured to move radially relative to the cylindrical body and housing therein the first image capture device. The housing may additionally include a second telescopic portion configured to move radially relative to the cylindrical body and housing therein the second image capture device.

VII. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fail within the scope of the appended claims.

The above detailed description describes various features and functions of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules (including firmware modules) and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A system comprising:
a base plate;
a housing rotatable with respect to the base plate;
one or more motors configured to rotate the housing with respect to the base plate;
a first image capture device disposed within the housing and having a first field of view;
a second image capture device disposed within the housing and having a second field of view; and
a control system configured to:
receive, from the first image capture device, first data representing a portion of an environment within the first field of view;
determine, based on the first data, a first object within the portion of the environment;
based on a position of the first object, determine a first direction in which to rotate the housing;
provide instructions to cause the motor to rotate the housing in the first direction; and
receive, from the second image capture device, second data representing the first object.

2. The system of claim 1, wherein:
the housing comprises a first housing portion coaxial with and rotatable independently of a second housing portion,
the first image capture device is disposed within the first housing portion,
the second image capture device is disposed within the second housing portion,
the system further comprises a second motor configured to rotate the first housing portion with respect to the second housing portion,
the control system is configured to determine the first direction in which to rotate the housing by, based on an angular position of the first housing portion in relation to the second housing portion, determining an angular displacement by which to rotate the second housing portion to position the first object within the second field of view, and
the control system is configured to provide the instructions to cause the motor to rotate the housing in the first direction by providing instructions to cause the second motor to rotate the second housing with respect to the first housing portion in the first direction by the angular displacement.

3. The system of claim 1, wherein the first field of view overlaps with the second field of view, wherein the first image capture device is disposed within the housing in a fixed position in relation to the second image capture device, wherein the second field of view is smaller than the first field of view, and wherein a position of the first object is beyond the second field of view.

4. The system of claim 1, wherein the housing comprises a cylindrical housing including in a bottom thereof a cylindrical recess, and wherein the base plate comprises a cylindrical plate disposed within the cylindrical recess.

5. The system of claim 1, wherein rotating the housing with respect to the base plate controls a horizontal position of the first field of view and the second field of view, and wherein the system further comprises:
a second motor configured to rotate at least one of the first image capture device or the second image capture device with respect to the housing to control a vertical position of at least one of the first field of view or the second field of view, respectively.

6. The system of claim 1, wherein the system further comprises:
a position encoder disposed within the housing and configured to generate a signal indicative of an angular position of the housing with respect to the base plate, wherein the control system is configured to determine the first direction in which to rotate the housing by:
receiving the signal from the position encoder; and
based on the signal from the position encoder, determining an angular displacement by which to rotate the housing in the first direction to position the first object within the second field of view; and
wherein the control system is configured to provide the instructions to cause the motor to rotate the housing in the first direction by, based on the signal from the position encoder, providing instructions to cause the motor to rotate the housing with respect to the base plate in the first direction by the angular displacement.

7. The system of claim 1, wherein the control system is configured to determine the first object within the portion of the environment by:
determining, based on the first data, a plurality of objects within the portion of the environment, wherein the plurality of objects includes the first object, and wherein the control system is further configured to:
transmit, to a computing device, image data representing each of the plurality of objects, wherein reception of the image data causes the computing device to display, in a first portion of a user interface, visual representations of the plurality of objects;
receive, from the computing device, a selection of the first object; and
in response to receiving the selection of the first object, transmit, to the computing device, the second data, wherein the second data comprises a video stream, and wherein reception of the second data causes the computing device to display, in a second portion of the user interface, the video stream.

8. The system of claim 1, wherein the control system is further configured to:
receive, from a computing device, instructions to reposition at least one of the first field of view or the second field of view in a second direction relative to the environment; and
in response to receiving the instructions, provide instructions to cause the motor to rotate the housing in the second direction.

9. The system of claim 1, wherein the base plate comprises a fastener configured to mechanically couple the base plate to a camera support structure.

10. The system of claim 1, wherein a wireless tag is communicatively connected to the control system and configured to transmit data indicative of a location of the wireless tag, and wherein the control system is configured to determine the first direction in which to rotate the housing by:
receiving, from the wireless tag, data indicative of the location of the wireless tag, wherein the wireless tag is disposed on at least one object within the environment; and
determining the first direction in which to rotate the housing to position the first object within the second field of view further based on the data indicative of the location of the wireless tag.

11. The system of claim 1, wherein the first data represents the portion of the environment from a first perspective, and wherein the control system is configured to determine the first direction in which to rotate the housing to position the first object within the second field of view by:
receiving, from a third image capture device disposed within a second housing, third data representing the first object from a second perspective different from the first perspective; and
determining the first direction in which to rotate the housing to position the first object within the second field of view further based on the third data.

12. The system of claim 1, wherein the position of the first object is a first position of the first object within a first image represented by the first data, wherein the first image capture device is separated from the second image capture device by a first distance, and wherein the control system is further configured to:
determine a second distance between the first object and at least one of the first image capture device or the second image capture device based on (i) the first distance, (ii) the first position, and (iii) a second position of the first object within a second image represented by the second data and corresponding to the first image; and
based on the second distance, adjust values of one or more parameters of the second image capture device to modify an image quality of the second data.

13. An apparatus comprising:
a housing including in a bottom thereof a recess;
a base plate rotatably coupled to the housing and disposed within the recess;
a motor configured to rotate the housing with respect to the base plate;
a first image capture device disposed within the housing and having a first field of view;
a second image capture device disposed within the housing and having a second field of view; and
a processor operable to provide instructions to cause the motor to rotate the housing with respect to the base plate to maintain one or more objects in an environment within at least one of the first field of view or the second field of view.

14. The apparatus of claim 13, wherein the housing is a cylindrical housing, wherein the recess is a cylindrical recess, and wherein the base plate is a cylindrical base plate.

15. The apparatus of claim 13, wherein the housing comprises a first housing portion coaxial with and rotatable independently of a second housing portion, wherein the first image capture device is disposed within the first housing portion, wherein the second image capture device is disposed within the second housing portion, wherein the apparatus further comprises a second motor configured to rotate the first housing portion with respect to the second housing portion, and wherein the processor is further operable to provide instructions to cause the second motor to rotate the first housing portion with respect to the second housing portion to maintain the one or more objects in the environment within at least one of the first field of view or the second field of view based on an angular position of the first housing portion in relation to the second housing portion.

16. The apparatus of claim 13, wherein rotating the housing with respect to the base plate controls a horizontal position of the first field of view and the second field of view, and wherein the apparatus further comprises:
a second motor configured to rotate at least one of the first image capture device or the second image capture device with respect to the housing to control a vertical position of at least one of the first field of view or the second field of view, respectively.

17. The apparatus of claim 13, wherein the housing comprises:
a cylindrical body rotatably coupled to the base plate;
a first telescopic portion configured to move radially relative to the cylindrical body and housing therein the first image capture device; and
a second telescopic portion configured to move radially relative to the cylindrical body and housing therein the second image capture device.

18. The apparatus of claim 13, wherein a wireless tag is communicatively connected to the processor and configured to transmit data indicative of a location of the wireless tag, and wherein the processor is operable to provide instructions to cause the motor to rotate the housing with respect to the base plate to maintain the one or more objects in the environment within the at least one of the first field of view or the second field of view by:
receiving, from the wireless tag, data indicative of the location of the wireless tag, wherein the wireless tag is disposed on at least one of the one or more objects within the environment;
determining a first direction in which to rotate the housing to maintain the one or more objects in the environment within the at least one of the first field of view or the second field of view based on the data indicative of the location of the wireless tag; and
providing instructions to cause the motor to rotate the housing in the first direction.

19. A method comprising:
receiving, by a control system, from a first image capture device disposed within a housing and having a first field of view, first data representing a portion of an environment within the first field of view;
determining, by the control system and based on the first data, a first object within the portion of the environment, wherein a position of the first object is beyond a second field of view of a second image capture device disposed within the housing, and wherein the second field of view is smaller than the first field of view;
based on the position of the first object, determining, by the control system, a first direction in which to rotate the housing with respect to a base plate to position the first object within the second field of view;
providing, by the control system, instructions to cause a motor to rotate the housing in the first direction; and
receiving, by the control system and from the second image capture device, second data representing the first object.

20. The method of claim 19, further comprising:
determining, based on the first data, a plurality of objects within the portion of the environment, wherein the plurality of objects includes the first object;
transmitting, to a computing device, image data representing each of the plurality of objects, wherein reception of the image data causes the computing device to display, in a first portion of a user interface, visual representations of the plurality of objects;
receiving, from the computing device, a selection of the first object; and
in response to receiving the selection of the first object, transmitting, to the computing device, the second data, wherein the second data comprises a video stream, and wherein reception of the second data causes the computing device to display, in a second portion of the user interface, the video stream.
